(19) United States
(12) Patent Application Publication
(10) Pub. No.: US 2010/0022745 A1
(43) Pub. Date: Jan. 28, 2010

(54) ONE COMPONENT RESIN COMPOSITION CURABLE WITH COMBINATION OF LIGHT AND HEAT AND USE OF THE SAME

(75) Inventors: Fumito Takeuchi, Sodegaura-shi (JP); Takahisa Miyawaki, Sodegaura-shi (JP); Kenji Itou, Sodegaura-shi (JP); Kenichi Yashiro, Sodegaura-shi (JP); Kei Nagata, Sodegaura-shi (JP); Souta Itou, Sodegaura-shi (JP); Tazo Ikeguchi, Osaka-shi (JP); Nobuo Sasaki, Osaka-shi (JP); Makoto Nakahara, Osaka-shi (JP)

Correspondence Address: BUCHANAN, INGERSOLL & ROONEY PC, POST OFFICE BOX 1404, ALEXANDRIA, VA, 22313-1404, US

(73) Assignees: MITSUI CHEMICALS, INC., Minato-Ku (JP); SHARP KABUSHIKI KAISHA, Osaka-shi (JP)

(21) Appl. No.: 12/572,420

(22) Filed: Oct. 2, 2009

Related U.S. Application Data
(62) Division of application No. 10/580,852, filed on May 26, 2006.

(30) Foreign Application Priority Data
Nov. 26, 2003 (JP) 2003-395683

(51) Int. Cl. C08G 65/04

(52) U.S. Cl. 528/421

(57) ABSTRACT

A one component resin composition curable with a combination of light and heat, which comprises (1) an epoxy resin, (2) an acrylic ester monomer and/or methacrylic ester monomer, or an oligomer thereof, (3) a latent epoxy curing agent, (4) a photo radical initiator, and (5) a compound having two or more thiol groups per molecule, wherein the ingredient (5) is contained in an amount of 0.001 to 5.0 parts by weight per 100 parts by weight of this resin composition. According to the present invention, a one component resin composition curable with a combination of light and heat, which has excellent curability especially in a light-shielded area can be provided. Also, a liquid crystal sealant composition curable with a combination of light and heat, which is applicable to the one-drop-fill method and has excellent curability in light-shielded areas and adhesion reliability, especially high-temperature and high-humidity adhesion reliability, can be provided.

### TECHNICAL FIELD

The present invention relates to a one component resin composition curable with a combination of light and heat, and use of the same. More specifically, the invention relates to a one component resin composition curable with a combination of light and heat, a liquid crystal sealant composition (in particular, a liquid crystal sealant composition which is applicable to a one-drop-fill method) comprising the same, a production process for a liquid crystal display panel using the same, and a liquid crystal display panel.

### BACKGROUND ART

Conventionally, there has been known a process in which the electronic parts such as a chip resistor or a condenser are soldered onto a print substrate, the electronic parts are temporarily fixed onto the print substrate using a one component resin composition curable with a combination of light and heat as an adhesive. This process is intended to overcome disadvantages, as in the case when the temporary fixing is conducted by using only a light-curable adhesive, such as short controllable reaction time and easy occurrence of misalignment, so as to provide the resin composition that is heat-curable as well as light-curable. Furthermore, predetermined positions of where resin composition is temporarily fixed, is thickened by light irradiation to play its role as the temporary fixing, and then completely curing by means of heat curing, so as to improve heat resistance or adhesiveness.

In addition, in recent years, liquid crystal display panels having the characteristics of being light-weight and high-definition have been widely used as display panels for a variety of apparatuses including cellular phones. As a process for producing such a liquid crystal display panel, conventionally, there has been a broadly carried out process, which comprises applying a heat-curable sealant composition having an epoxy resin as the main ingredient on a glass substrate for a liquid crystal display, performing a pre-curing treatment, joining opposite facing substrates to each other and heat-pressing the resultant, forming a cell for encapsulating the liquid crystal, injecting the liquid crystal into the cell under vacuum, and then sealing the inlet for injecting the liquid crystal after injection.

However, during the process of producing a liquid crystal display panel as described above, cell gap variation is likely to occur due to heat distortion upon heat-curing, and further, the step for injecting the liquid crystal is time-consuming, which was disadvantageous in shortening the time for production process so as to improve the productivity of a small-sized liquid crystal display panel having high-definition, or a large-sized liquid crystal display panel.

As a method for solving these problems, it has been conventionally proposed to use a light-curable acryl-based liquid crystal sealant having an acrylic acid ester or methacrylic acid ester as the main ingredient, a light-curable epoxy-based liquid crystal sealant, a liquid crystal sealant curable with a combination of heat and light which has a partial acrylate or partial methacrylate of a Novolac type epoxy resin as the main ingredient, or the like.

Among them, with reference to a liquid crystal sealant curable with a combination of heat and light, a process has been proposed which comprises applying a sealant on a substrate having an electrode pattern and an alignment film under vacuum condition, dropping liquid crystal on the substrate having the sealant applied thereon or a substrate to be paired therewith, joining opposite facing substrates to each other after dropping liquid crystal, performing light-curing by means of UV irradiation, etc., in the first step to allow rapid fixing of the substrates, namely, formation of a cell gap, and performing complete curing of the sealant by heat-curing without using a pressing jig in the second step. For example, Patent Document 1 discloses a means which is applicable to a one-drop-fill method, but was not necessarily satisfactory in reliability of the light-shielded area of the wiring section. Patent Document 2 discloses a liquid crystal sealant composition applicable to a one-drop-fill method, which comprises a light-curable ingredient, a heat-curable ingredient, and a light curing agent, having defined values with the respect to the amount of reduced resistivity of liquid crystal and the variation in the phase transition points of liquid crystal. However, the document has no description on the characteristics of a gap formation after light-curing the sealant composition, and the curability in the light-shielded area of the wiring section. Thus, the reliability of the resultant liquid crystal display panel was not necessarily ensured.

Furthermore, the liquid crystal sealant composition is required to be able to have adhesion reliability when left to stand for a long time under high-temperature and high-humidity, maintenance of the electro-optical characteristics of liquid crystal, no occurrence of disorientation of liquid crystal, or the like.

In addition, Patent Document 3 proposes a light-curable sealing agent for a liquid crystal inlet, which comprises a polythiol compound having two or more thiol groups per molecule, a polyene compound having two or more carbon-carbon double bonds per molecule, and a photopolymerization initiator. However, this light-curable resin composition has neither sufficient adhesiveness nor adhesion reliability for use as a liquid crystal sealant composition.

The present inventors have made extensive studies in order to solve the above-described problems, and as a result, they have found that the problems can be solved by a specific one component resin composition curable with a combination of light and heat, thus leading to completion of the invention.

[Patent Document 1] JP-A No. 9-5759

[Patent Document 2] JP-A No. 2001-133794

[Patent Document 3] Japanese Patent No. 3048478

### SUMMARY OF THE INVENTION

It is an object of the present invention to provide a one component resin composition curable with a combination of light and heat, which has excellent curability, especially in a light-shielded area.

Further, it is another object of the invention to provide a liquid crystal sealant composition which is desirably applicable to a one-drop-fill method. Specifically, it is an object of the invention to provide a one component resin composition curable with a combination of light and heat, wherein it has excellent stability of a cell gap after forming of the cell gap by light-curing in the first step, and prevent contamination of liquid crystal during heat-curing in the second step, does not cause disorientation of liquid crystal so as to maintain the electric characteristics of liquid crystal, and has excellent adhesion reliability, in particular, high-temperature and high-humidity adhesion reliability.

Further, it is another object of the invention to provide a process for producing a liquid crystal display panel using the above-described liquid crystal sealant composition by means of a one-drop-fill method, and a liquid crystal display panel.

The one component resin composition curable with a combination of light and heat according to the present invention is characterized in that it comprises (1) an epoxy resin, (2) an acrylic ester monomer and/or methacrylic ester monomer, or an oligomer thereof, (3) a latent epoxy curing agent, (4) a photo radical initiator, and (5) a compound having two or more thiol groups per molecule, wherein the ingredient (5) is contained in an amount of 0.001 to 5.0 parts by weight per 100 parts by weight of the resin composition.

The one component resin composition curable with a combination of light and heat of the invention is characterized in that it preferably comprises 1 to 60 parts by weight of the ingredient (1), 5 to 97.989 parts by weight of the ingredient (2), 1 to 25 parts by weight of the ingredient (3), 0.01 to 5 parts by weight of the ingredient (4), and 0.001 to 5.0 parts by weight of the ingredient (5), based on 100 parts by weight of the total of the ingredients (1) to (5).

The above-described ingredient (5) is preferably a mercaptoester obtained by the reaction of a mercaptocarboxylic acid with a polyhydric alcohol.

The one component resin composition curable with a combination of light and heat of the invention preferably comprises a partially esterified epoxy resin (6) obtained by the reaction of an epoxy resin with a compound having both at least one acryloyl group or methacryloyl group, and at least one carboxyl group per molecule.

Further, the liquid crystal sealant composition according to the invention is characterized in that it comprises the above-described one component resin composition curable with a combination of light and heat.

The liquid crystal sealant composition of the invention may comprise a thermoplastic polymer (7) having a softening point, as measured by a ring and ball method, of 50 to 120° C., which is obtained by the copolymerization of an acrylic ester monomer and/or methacrylic ester monomer, and a monomer copolymerizable therewith, in addition to the above-described ingredients (1) to (6). As used herein, the softening point refers to those as measured by a ring and ball method in accordance with JISK2207.

Further, the process for producing a liquid crystal display panel of the invention is characterized in that light-curing and heat-curing are carried out in this order, using the above-described liquid crystal sealant composition in the one-drop-fill method.

The liquid crystal display panel of the invention is also characterized in that it is produced by the above-described process for producing a liquid crystal display panel.

According to the invention, a one component resin composition curable with a combination of light and heat, which has excellent curability, especially in a light-shielded area, can be provided. Further, a liquid crystal sealant composition curable with a combination of light and heat, which is applicable to a one-drop-fill method having excellent characteristics of the cured product after light-curing and the stability of the cell gap after formation of a cell gap in the first step; and preventing the contamination of liquid crystal during heat-curing in the second step; and has excellent curability in a light-shielded area, as well as excellent adhesion reliability, especially, high-temperature and high-humidity adhesion reliability, can be further provided.

Further, according to the invention, by using the liquid crystal sealant composition, a liquid crystal display panel which has excellent display characteristics, especially liquid crystal display characteristics with respect to the shielded area of the wiring section can be provided.

### DETAILED DESCRIPTION OF THE INVENTION

Hereinafter, the one component resin composition curable with a combination of light and heat, and the liquid crystal sealant composition comprising the same will be explained in detail.

<One Component Resin Composition Curable with Combination of Light and Heat>

The one component resin composition curable with a combination of light and heat according to the invention comprises an epoxy resin (1), an acrylic ester monomer and/or methacrylic ester monomer, or an oligomer thereof (2), a latent epoxy curing agent (3), a photo radical initiator (4), and a compound having two or more thiol groups per molecule (5) in specific amounts, and further, preferably comprises a partially esterified epoxy resin (6) obtained by the reaction of an epoxy resin with a compound having both at least one acryloyl group or methacryloyl group, and at least one carboxyl group per molecule.

First, each of these ingredients will be explained in detail.

(1) Epoxy Resin

Specific examples of the epoxy resin which can be used in the invention include aliphatic polyvalent glycidyl ether compounds obtained by the reaction of polyhydric alcohols, typically such as polyalkylene glycols such as ethylene glycol, diethylene glycol, triethylene glycol, polyethylene glycol, propylene glycol, dipropylene glycol, tripropylene glycol and polypropylene glycol, dimethylolpropane, trimethylolpropane, spiroglycol and glycerin with epichlorohydrin, aromatic polyvalent glycidyl ether compounds obtained by the reaction of aromatic diols, typically such as bisphenol A, bisphenol S, bisphenol F and bisphenol AD, and their diols modified with alkylene glycols such as ethylene glycol and propylene glycol with epichlorohydrin;

aliphatic polyvalent glycidyl ester compounds obtained by the reaction of aliphatic dicarboxylic acids, typically such as adipic acid and itaconic acid with epichlorohydrin; aromatic polyvalent glycidyl ester compounds obtained by the reaction of aromatic dicarboxylic acids, typically such as isophthalic acid, terephthalic acid and pyromellitic acid with epichlorohydrin; aliphatic polyvalent glycidyl ether ester compounds, aromatic polyvalent glycidyl ether ester compounds or alicyclic polyvalent glycidyl ether compounds, obtained by the reaction of hydroxydicarboxylic acid compounds with epichlorohydrin; aliphatic polyvalent glycidyl amine compounds obtained by the reaction of aliphatic diamines, typically such as polyethylene diamine with epichlorohydrin; aromatic polyvalent glycidyl amine compounds obtained by the reaction of aromatic diamine, typically such as diaminodiphenylmethane, aniline and metaxylylenediamine with epichlorohydrin; hydantoin type polyvalent glycidyl compounds obtained by the reaction of hydantoin and a derivative thereof with epichlorohydrin; Novolac type polyvalent glycidyl ether compounds obtained by the reaction of polyphenols, typically such as a Novolac resin derived from either phenol or cresol and formaldehyde, polyalkenyl phenol and a copolymer thereof, with epichlorohydrin; epoxidized diene polymers such as epoxidized polybutadiene and epoxidized polyisoprene; 3,4-epoxy-6-methylcyclohexylmethyl-3,4-epoxy-6-methylcyclohexane carbonates; bis(2,3-epoxycyclopentyl)ethers; urethane modified epoxy resins; polysulfide modified epoxy resins; rubber modified epoxy resins (modified with CTBN, ATBN etc.); polyalkylene glycol epoxy resins; bisphenol A epoxy resins having ether elastomers added thereto; silicone rubber modified epoxy resins; acryl modified epoxy resins; or the like.

These may be used alone or in a combination of two or more kinds.

The epoxy resin (1) is used in the one component resin composition curable with a combination of light and heat, in an amount of usually 1 to 60 parts by weight, and preferably 10 to 64 parts by weight, based on 100 parts by weight of the total of the ingredient (1), and the ingredients (2) to (5) as described below.

(2) Acrylic Ester Monomer and/or Methacrylic Ester Monomer, or Oligomer Thereof.

The acrylic ester monomer and/or methacrylic ester monomer, or an oligomer thereof (2) which can be used in the invention is exemplified by the followings: diacrylate and/or dimethacrylate of tris(2-hydroxyethyl)isocyanurate; triacrylate and/or trimethacrylate of tris(2-hydroxyethyl) isocyanurate; trimethylolpropane triacrylate and/or trimethacrylate, or an oligomer thereof; pentaerythritol triacrylate and/or trimethacrylate, or an oligomer thereof; polyacrylate and/or polymethacrylate of dipentaerythritol; tris(acryloxyethyl)isocyanurate; caprolactone-modified tris(acryloxyethyl)isocyanurate; caprolactone-modified tris(methacryloxyethyl)isocyanurate; polyacrylate and/or polymethacrylate of alkyl-modified dipentaerythritol; polyacrylate and/or polymethacrylate of caprolactone-modified dipentaerythritol; or the like. These may be used alone or in a combination of two or more kinds.

The acrylic ester monomer and/or methacrylic ester monomer, or an oligomer thereof (2) is used in the one component resin composition curable with a combination of light and heat, in an amount of usually 5 to 97.989 parts by weight, and preferably 10 to 84.945 parts by weight, based on 100 parts by weight of the total of the ingredients (1) and (2), and the ingredients (3) to (5) as described below.

(3) Latent Epoxy Curing Agent

As the latent epoxy curing agent (3), a known latent epoxy curing agent can be used, but amine-based latent curing agents such as organic acid dihydrazide compounds, imidazole and a derivative thereof, dicyandiamide and aromatic amine are preferable from the standpoint that they are capable of providing a blend having good viscosity stability as a one component. These may be used alone or in a combination of two or more kinds.

When such the amine-based latent curing agent is used, the nucleophilic addition characteristics of the active hydrogen contained in the amine-based latent curing agent to the acryloyl group and/or methacryloyl group in the molecule of the above-described ingredient (2) by heat become good, and therefore, heat-curability in the light-shielded area is improved, which is thus preferable.

Among these, an amine-based latent curing agent, which has a melting point, or a softening point, as measured by a ring and ball method, of 100° C. or higher is preferable. When the amine-based latent curing agent has a melting point, or a softening point, as measured by a ring and ball method, of 100° C. or higher, the viscosity stability at room temperature can be maintained, and therefore the amine-based latent curing agent can be used for an extended period of time by screen printing or dispenser coating.

Specific examples of the amine-based latent curing agent, which has a melting point, or a softening point, as measured by a ring and ball method, of 100° C. or higher, include dicyandiamides such as dicyandiamide (m.p. 209° C.); organic acid dihydrazides such as adipic acid dihydrazide (m.p. 181° C.), and 1,3-bis(hydrazinocarboethyl)-5-isopropylhydantoin (m.p. 120° C.); imidazole derivatives such as 2,4-diamino-6-[2′-methylimidazolyl-(1′)]-ethyl triazine (m.p. 215 to 225° C.), and 2-phenylimidazole (m.p. 137 to 147° C.); and the like.

The latent epoxy curing agent (3) is used in the one component resin composition curable with a combination of light and heat, in an amount of usually 1 to 25 parts by weight, and preferably 5 to 20 parts by weight, based on 100 parts by weight of the total of the ingredients (1) to (3), and the ingredients (4) and (5) as described below.

(4) Photo Radical Initiator

The photo radical initiator (4) which can be used in the invention is not particularly limited, and a well-known material can be used. Specific examples thereof include benzoin-based compounds, acetophenones, benzophenones, thioxantones, anthraquinones, α-acyloxime esters, phenylglyoxylates, benzils, azo compounds, diphenyl sulfide-based compounds, acylphosphine oxide-based compounds, organic colorant-based compounds, iron-phthalocyanine-based compounds, and the like. These may be used alone or in a combination of two or more kinds.

The photo radical initiator (4) is used in the one component resin composition curable with a combination of light and heat, in an amount of usually 0.01 to 5 parts by weight, and preferably 0.05 to 3 parts by weight, based on 100 parts by weight of the total of the ingredients (1) to (4), and the ingredient (5) as described below.

(5) Compound Having Two or More Thiol Groups Per Molecule

The compound having two or more thiol groups per molecule (5) which can be used in the invention is not particularly limited as long as it has two or more thiol groups per molecule, but examples thereof include mercaptoesters which are ester-based thiol compounds obtained by the reaction of mercaptocarboxylic acids with polyhydric alcohols, aliphatic polythiols, aromatic polythiols, thiol-modified reactive silicone oils; and the like.

Examples of the mercaptocarboxylic acids which are preferably used to obtain mercaptoesters, include thioglycolic acid, α-mercaptopropionic acid, β-mercaptopropionic acid, or the like, and examples of the polyhydric alcohols for the same purpose as above include ethanediol, propylene glycol, 1,4-butanediol, 1,6-hexanediol, glycerin, trimethylolpropane, ditrimethylolpropane, pentaerythritol, dipentaerythritol, sorbitol, or the like.

The mercaptoesters obtained by the reaction of the above-described mercaptocarboxylic acids with the polyhydric alcohols include, for example, trimethylolpropane tris(3-mercaptopropionate), 2-ethylhexyl-3-mercaptopropionate, or the like.

Examples of the aliphatic polythiols include decane thiol, ethane dithiol, propane dithiol, hexamethylene dithiol, decamethylene dithiol, diglycol dimercaptan, triglycol dimercaptan, tetraglycol dimercaptan, thiodiglycol dimercaptan, thiotriglycol dimercaptan or thiotetraglycol dimercaptan, as well as cyclic sulfide compounds such as 1,4-dithiane ring containing polythiol compounds; episulfide resin modified polythiols obtained by the addition reaction of the episulfide resin with active hydrogen compounds such as amine; or the like.

Further, examples of the aromatic polythiols include tolylene-2,4-dithiol, xylylene dithiol, or the like.

Examples of the thiol modified reactive silicone oils include mercapto-modified dimethylsiloxane, mercapto-modified diphenyl siloxane, or the like.

These may be used alone or in a combination of two or more kinds.

Among these, mercaptoesters obtained by the esterification reaction of mercaptocarboxylic acids with polyhydric alcohols are preferable.

The compound having two or more thiol groups per molecule (5) is contained in an amount of usually 0.001 to 5.0 parts by weight, and preferably 0.005 to 3.0 parts by weight, based on 100 parts by weight of the one component resin composition curable with a combination of light and heat.

The compound having two or more thiol groups per molecule (5) is desirably used in the one component resin composition curable with a combination of light and heat, in an amount of usually 0.001 to 5.0 parts by weight, and preferably 0.005 to 3.0 parts by weight, based on 100 parts by weight of the total of the ingredients (1) to (5).

(6) Partially Esterified Epoxy Resin Obtained by the Reaction of an Epoxy Resin with a Compound Having Both at Least One Acryloyl Group or Methacryloyl Group, and at Least One Carboxyl Group Per Molecule

For the one component resin composition curable with a combination of light and heat of the invention, a partially esterified epoxy resin obtained by the reaction of an epoxy resin with a compound having both at least one acryloyl group or methacryloyl group, and at least one carboxyl group per molecule (6) may be used, if necessary.

An epoxy resin for esterification is not particularly limited, and the epoxy resins as described above for the ingredient (1) can be employed. The partially esterified epoxy resin (6) can be obtained by the reaction of such the epoxy resin with a compound having both at least one acryloyl group or methacryloyl group, and at least one carboxyl group per molecule of 0.2 to 0.9 equivalent, and preferably 0.4 to 0.9 equivalent relative to 1 equivalent of epoxy group of the epoxy resin in the presence of a basic catalyst.

Specific examples of the compound having both at least one acryloyl group or methacryloyl group, and at least one carboxyl group per molecule include acrylic acid, methacrylic acid, 2-methacryloyloxyethylphthalic acid, 2-methacryloyloxyethylsuccinic acid, 2-methacryloyloxyethylhydrophthalic acid, 2-methacryloyloxyethylmaleic acid, 2-methacryloyloxypropylphthalic acid, 2-methacryloyloxypropylsuccinic acid, 2-methacryloyloxypropylmaleic acid, 2-acryloyloxyethylsuccinic acid, 2-acryloyloxyethylphthalic acid, 2-acryloyloxyethylhydrophthalic acid, 2-acryloyloxyethylmaleic acid, 2-acryloyloxypropylphthalic acid, 2-acryloyloxypropylsuccinic acid, 2-acryloyloxypropylmaleic acid, or the like. These may be used alone or in a combination of two or more kinds.

The partially esterified epoxy resin (6) can be used in the one component resin composition curable with a combination of light and heat, in an amount such that the total amount of the above-described epoxy resin (1) and the acrylic ester monomer and/or methacrylic ester monomer, or an oligomer thereof (2) is usually 160 to 800 parts by weight, and preferably 200 to 500 parts by weight, based on 100 parts by weight of the partially esterified epoxy resin (6).

Other Ingredients

Further, for the one component resin composition curable with a combination of light and heat of the invention, a thermoplastic polymer (7) which is obtained by the copolymerization of an acrylic ester monomer and/or methacrylic ester monomer, and a monomer copolymerizable therewith, a filler (8), other additives (9), or the like can be suitably used according to the applications as described below.

### <Liquid Crystal Sealant Composition>

(1-1) Epoxy Resin

The liquid crystal sealant composition of the invention comprises the above-described one component resin composition curable with a combination of light and heat, wherein the one component resin composition curable with a combination of light and heat may be used as is as the liquid crystal sealant composition, or may be obtained by adding other ingredients to the one component resin composition curable with a combination of light and heat.

For the epoxy resin (1-1), which can be used for the liquid crystal sealant composition of the invention, the above-described epoxy resin (1) can be used, among which a solid epoxy resin having a softening point, as measured by a ring and ball method, of 40° C. or higher is preferable. The solid epoxy resin is not limited by the kind thereof, as long as it has a softening point of 40° C. or higher, and is solid at ambient temperature. As used herein, the softening point refers to those as measured by a ring and ball method in accordance with JISK2207.

When the solid epoxy resin has a softening point, as measured by a ring and ball method, of 40° C. or higher, the glass transition temperature of the cured product after light-curing, and the gel fraction of the cured product after heat-curing, of the obtained liquid crystal sealant composition, become higher, respectively, and the glass transition temperature of the cured product after curing with a combination of light and heat also becomes higher, which is thus preferable.

Further, the number average molecular weight of the solid epoxy resin is preferably in the range of 500 to 2000. When the number average molecular weight is within this range, solubility or dispersibility of the solid epoxy resin to liquid crystal becomes lower, and thus display characteristics of the obtained liquid crystal display panel are good, and compatibility with the acrylic ester monomer and/or methacrylic ester monomer, or an oligomer thereof (2-1) as described below is good, which is thus preferable. The number average molecular weight of the solid epoxy resin can be measured, for example, using polystyrene as a standard by a gel permeation chromatography (GPC). The solid epoxy resin is preferably a resin obtained by means of high-purity treatment such as a molecular distillation method.

Specific examples of the solid epoxy resin having a softening point, as measured by a ring and ball method, of 40° C. or higher include aromatic polyvalent glycidyl ether compounds obtained by the reaction of aromatic diols, typically such as bisphenol A, bisphenol S, bisphenol F and bisphenol AD, and their diols modified with alkylene glycols such as ethylene glycol and propylene glycol with epichlorohydrin; Novolac type polyvalent glycidyl ether compounds obtained by the reaction of polyphenols, typically such as a Novolac resin derived from either phenol or cresol and formaldehyde, polyalkenylphenol or a copolymer thereof with epichlorohydrin; glycidyl ether compounds of xylylene phenol resins, or the like, which are specific examples of those having a softening point, as measured by a ring and ball method, of 40° C. or higher.

In particular, at least one resin selected from the group consisting of cresol Novolac type epoxy resins, phenol Novolac type epoxy resins, bisphenol A type epoxy resins, bisphenol F type epoxy resins, triphenol methane type epoxy resin, triphenol ethane type epoxy resins, trisphenol type epoxy resins, dicyclopentadiene type epoxy resins and biphenyl type epoxy resins, or a mixture thereof, which has/have a softening point, as measured by a ring and ball method, of 40° C. or higher, can be preferably used.

The epoxy resin (1-1) is used in the liquid crystal sealant composition, usually in an amount of 1 to 60 parts by weight, based on 100 parts by weight of the total of the ingredient (1-1) and the ingredients (2-1) to (5-1) as described below.

In a preferable embodiment, the epoxy resin (1-1) is used in the liquid crystal sealant composition, preferably in an amount of 5 to 40 parts by weight, and more preferably 10 to 30 parts by weight, based on 100 parts by weight of the liquid crystal sealant composition. When the amount of epoxy resin is within this range, the glass transition temperature of the cured product after light-curing, and the gel fraction of the cured product after heat-curing, of the liquid crystal sealant composition, become higher, respectively, and the glass transition temperature (Tg) of the cured product after curing with a combination of light and heat also becomes higher, which is thus preferable.

Further, the epoxy resin (1-1) is preferably used in an amount of 20 to 200 parts by weight, and more preferably 50 to 150 parts by weight, based on 100 parts by weight of the acrylic ester monomer and/or methacrylic ester monomer, or an oligomer thereof (2-1) as described later. When the ratio of the ingredient (1-1) to the ingredient (2-1) is within this range, Tg of the cured product after light-curing and after curing with a combination of light and heat tends to become high, which is preferable.

(2-1) Acrylic Ester Monomer and/or Methacrylic Ester Monomer, or Oligomer Thereof.

For the acrylic ester monomer and/or methacrylic ester monomer, or an oligomer thereof (2-1) which can be used in the liquid crystal sealant composition of the invention, the above-described acrylic ester monomer and/or methacrylic ester monomer, or an oligomer thereof (2) can be used, among which those having a number average molecular weight in the range of 250 to 2000 and a theoretical solubility parameter (sp value) by Fedors method, in the range of 10.0 to 13.0 (cal/cm³)^{1/2} is preferable. When the number average molecular weight is within this range, solubility or dispersibility of the acrylic ester monomer and/or methacrylic ester monomer, or an oligomer thereof (2-1) to liquid crystal becomes lower, and thus display characteristics of the obtained liquid crystal display panel is good, and compatibility with the solid epoxy resin, which is a preferable embodiment of the above-described ingredient (1-1) is good. The number average molecular weight of the acrylic ester monomer and/or methacrylic ester monomer, or an oligomer thereof (2-1) can be measured, for example, using polystyrene as a standard by a gel permeation chromatography (GPC).

There exist various means or calculation methods for determining the solubility parameter (sp value), but the theoretical solubility parameter as used herein is based on the calculation method designed by Fedors (see Japan Adhesion Society, Vol. 22, No. 10 (1986) (53) (566), etc.). For this calculation method, the value of density is not required, which allows easy calculation of the solubility parameter. The above-described theoretical solubility parameter by Fedors method is calculated by the following equation.

(ΣΔe1/ΣΔv1)^{1/2}

(provided that, ΣΔe1=(ΔH−RT), and ΣΔv1: sum of molarities)

When the solubility parameter (sp value) is within this range, solubility of the acrylic ester monomer and/or methacrylic ester monomer, or an oligomer thereof (2-1) to liquid crystal is low, and contamination in the liquid crystal is prevented; therefore, display characteristics of the obtained liquid crystal display panel is good, which is thus preferable.

Also, when the solubility parameter is within this range, the nucleophilic addition reactivities of the active hydrogen of the latent epoxy curing agent (3-1) and the compound having two or more thiol groups per molecule (5-1) as described below to acryloyl group and/or methacryloyl group of the acrylic ester monomer and/or methacrylic ester monomer, or an oligomer thereof (2-1) in heat treatment, that is, a curing reactivity by heat becomes good, and thus curability is further improved in the light-shielded area of the wiring section, which is thus preferable.

According to the invention, for the acrylic ester monomer and/or methacrylic ester monomer, or an oligomer thereof (2-1), a composition obtained by combination of several kinds of those as described for the ingredient (2) can also be used. In this case, the theoretical solubility parameter (sp value) of a composition thereof can be calculated on the basis of the total sum of the molar fractions of each of the acrylic ester monomer, methacrylic ester monomer, or an oligomer thereof.

Further, for the acrylic ester monomer and/or methacrylic ester monomer, or an oligomer thereof (2-1), even when the above-described composition is used, the theoretical solubility parameter of the whole composition is preferably in the range of 10.0 to 13.0 (cal/cm³)^{1/2}.

Specific examples of the acrylic ester monomer and/or methacrylic ester monomer, or an oligomer thereof (2-1) having a number average molecular weight in the range of 250 to 2000, and a theoretical solubility parameter (sp value) by Fedors method in the range of 10.0 to 13.0 (cal/cm³)^{1/2} include pentaerythritol triacrylate (number average molecular weight: 298, sp value: 11.1), pentaerythritol tetraacrylate (number average molecular weight: 352, sp value: 12.1), or the like.

The acrylic ester monomer and/or methacrylic ester monomer, or an oligomer thereof (2-1) is used in the liquid crystal sealant composition, usually in an amount of 5 to 97.989 parts by weight, based on 100 parts by weight of the total of the ingredients (1-1) and (2-1), and the ingredients (3-1) to (5-1) as described below.

In a preferable embodiment, the acrylic ester monomer and/or methacrylic ester monomer, or an oligomer thereof (2-1) is preferably used in an amount of 10 to 50 parts by weight, and more preferably 20 to 40 parts by weight, based on 100 parts by weight of the liquid crystal sealant composition.

Further, the acrylic ester monomer and/or methacrylic ester monomer, or an oligomer thereof (2-1) is preferably used after high-purity treatment by means of a water washing method or the like.

(3-1) Latent Epoxy Curing Agent

For the latent epoxy curing agent (3-1) which can be used in the liquid crystal sealant composition of the invention, the above-described latent epoxy curing agent (3) can be used.

In this case, the latent epoxy curing agent (3-1) is used in the liquid crystal sealant composition, usually in an amount of 1 to 25 parts by weight, based on 100 parts by weight of the total of the ingredients (1-1) to (3-1), and the ingredients (4-1) and (5-1) as described below.

In a preferable embodiment, the latent epoxy curing agent (3-1) is preferably used in an amount of 1 to 25 parts by weight, and more preferably 5 to 15 parts by weight, based on 100 parts by weight of the liquid crystal sealant composition. When the latent epoxy curing agent (3-1) is contained within this range, adhesion reliability of the obtained liquid crystal display panel is exhibited, and the viscosity stability of the liquid crystal sealant composition can be maintained.

Further, the latent epoxy curing agent (3-1) is preferably used after high-purity treatment by means of a water washing method, a recrystallization method, or the like.

(4-1) Photo Radical Initiator

For the photo radical initiator (4-1) which can be used in the liquid crystal sealant composition of the invention, the above-described photo radical initiator (4) can be used.

In this case, the photo radical initiator (4-1) is used in the liquid crystal sealant composition, usually in an amount of 0.01 to 5 parts by weight, based on 100 parts by weight of the total of the ingredients (1-1) to (4-1), and the ingredient (5-1) as described below.

In a preferable embodiment, the photo radical initiator (4-1) is preferably used in an amount of 0.01 to 5 parts by weight, and more preferably 0.1 to 3 parts by weight, based on 100 parts by weight of the liquid crystal sealant composition. When the amount thereof is adjusted to 0.01 parts by weight or more, curability by means of light radiation is imparted, and when the amount thereof is adjusted to 5 parts by weight or less, application stability of the liquid crystal sealant composition is good, which thus gives a uniform cured product upon light-curing.

(5-1) Compound Having Two or More Thiol Groups Per Molecule

For the compound having two or more thiol groups per molecule (5-1) which can be used in the invention, the above-described compound having two or more thiol groups per molecule (5) can be used, among which those having a number average molecular weight in the range of 300 to 2000 are preferable. When the number average molecular weight is within this range, solubility or dispersibility to liquid crystal becomes lower, and thus display characteristics of the obtained liquid crystal display panel are good. The number average molecular weight of the compound having two or more thiol groups per molecule (5-1) can be measured, for example, using polystyrene as a standard by a gel permeation chromatography (GPC).

In this case, the compound having two or more thiol groups per molecule (5-1) is used in the liquid crystal sealant composition, usually in an amount of 0.001 to 5.0 parts by weight, based on 100 parts by weight of the total of the ingredients (1-1) to (5-1).

In a preferable embodiment, the ingredient (5-1) is preferably used in an amount of 0.01 to 5.0 parts by weight, and more preferably 0.05 to 3.0 parts by weight, based on 100 parts by weight of the liquid crystal sealant composition.

When the content of the ingredient (5-1) is contained within this range, curability in the light-shielded area of the wiring section is sufficient, as well as there is no occurrence of an undesirable reaction thereof with the epoxy resin of the ingredient (1-1), and thus stability in the viscosity is good, which is therefore preferable.

(6-1) Partially Esterified Epoxy Resin Obtained by the Reaction of Epoxy Resin with Compound Having Both at Least One Acryloyl Group or Methacryloyl Group, and at Least One Carboxyl Group Per Molecule

For the liquid crystal sealant composition of the invention, the partially esterified epoxy resin obtained by the reaction of an epoxy resin with a compound having both at least one acryloyl group or methacryloyl group, and at least one carboxyl group per molecule (6-1) may be used, if necessary, in addition to the above-described ingredients (1-1) to (5-1).

For the partially esterified epoxy resin (6-1) which can be used in the liquid crystal sealant composition of the invention, the above-described partially esterified epoxy resin (6) can be used.

Since the partially esterified epoxy resin (6) has both an epoxy group and an acryloyl group and/or methacryloyl group in the resin skeleton, compatibility of the acrylic ester monomer and/or methacrylic ester monomer, or an oligomer thereof (2-1) with the epoxy resin (1-1) in the liquid crystal sealant composition can be improved, and thereby the glass transition temperature (Tg) of the cured product after light-curing can be increased, as well as adhesion reliability can be exhibited.

Further, among the partially esterified epoxy resin (6), for the compound having both at least one acryloyl group or methacryloyl group, and at least one carboxyl group per molecule, methacrylic acid, 2-methacryloyloxyethylphthalic acid, 2-methacryloyloxyethylsuccinic acid, 2-methacryloyloxyethylhydrophthalic acid, 2-methacryloyloxyethylmaleic acid, 2-methacryloyloxypropylphthalic acid, 2-methacryloyloxypropylsuccinic acid, or 2-methacryloyloxy propylmaleic acid is more preferably used.

When a partially esterified epoxy resin obtained by the reaction of an epoxy resin with the above-described compound having both at least one methacryloyl group, and at least one carboxyl group per molecule is used in the liquid crystal sealant composition, the glass transition temperature (Tg) of the cured product after light-curing tends to become high, and thus misalignment of the glass substrates is prevented, which is therefore more preferable.

When the partially esterified epoxy resin (6-1) is used in the liquid crystal sealant composition according to the invention, it is desirably contained preferably in an amount of 5 to 30 parts by weight, and more preferably 10 to 20 parts by weight, based on 100 parts by weight of the liquid crystal sealant composition.

Further, the partially esterified epoxy resin (6-1) is preferably contained in the liquid crystal sealant composition, such that the total sum of the epoxy resin (1-1) and the acrylic ester monomer and/or methacrylic ester monomer, or an oligomer thereof (2-1) is 160 to 800 parts by weight, and preferably 200 to 500 parts by weight, based on 100 parts by weight of the partially esterified epoxy resin (6-1).

When the partially esterified epoxy resin (6-1) is contained within this range with respect to the ingredients (1-1) and (2-1), the glass transition temperature (Tg) of the cured product after light-curing, and the gel fraction of the cured product after heat-curing tend to become high, respectively.

Further, the partially esterified epoxy resin (6-1) is preferably used after high-purity treatment by means of a water washing method or the like.

(7) Thermoplastic Polymer Having Softening Point of 50 to 120° C., which is Obtained by Copolymerization of Acrylic Ester Monomer and/or Methacrylic Ester Monomer, and Monomer Copolymerizable Therewith

For the liquid crystal sealant composition of the invention, the thermoplastic polymer (7) which is obtained by the copolymerization of an acrylic ester monomer and/or methacrylic ester monomer, and a monomer copolymerizable therewith may be used either alone or in combination with the ingredient (6-1), in addition to the above-described ingredients (1-1) to (5-1).

The softening point is preferably in the range of 50 to 120° C., and more preferably in the range of 60 to 80° C. It is preferable that the thermoplastic polymer has the softening point within this range from the following standpoints: when the obtained liquid crystal sealant composition is heated, the thermoplastic polymer is melted, and the thermoplastic polymer is compatibilized with the ingredients contained in this liquid crystal sealant composition, for example, the epoxy resin (1-1) and the acrylic ester monomer and/or methacrylic ester monomer, or an oligomer thereof (2-1). Further, the compatibilized thermoplastic polymer can be expanded to prevent the decrease in the viscosity of the liquid crystal sealant composition before curing by heating. Further, leakage of the ingredients of the liquid crystal sealant composition into liquid crystal, and diffusion of the ingredients to liquid crystal can be prevented.

The above-described thermoplastic polymer (7) preferably has a particle shape, may be crosslinked or non-crosslinked, and may also be of a composite type having a core/shell structure consisting of a crosslinked core layer and a non-crosslinked shell layer.

The average particle diameter of the thermoplastic polymer (7) is usually in the range of 0.05 to 5 μm, and preferably 0.07 to 3 μm from the standpoint of achieving high dispersibility in the liquid crystal sealant composition. As used herein, the average particle diameter refers to the mode diameter, as determined from the weight particle size distribution by a Coulter counter method.

For such the thermoplastic polymer (7), a well-known one can be arbitrarily selected and used, but specifically the thermoplastic polymer can be obtained in the form of an emulsion comprising the polymer particles by the copolymerization of usually 30 to 99.9% by weight, preferably 50 to 99.9% by weight, and more preferably 60 to 80% by weight of an acrylic ester monomer and/or methacrylic ester monomer, and usually 0.1 to 70% by weight, preferably 0.1 to 50% by weight, and more preferably 20 to 40% by weight of a monomer copolymerizable with the above monomer.

Specific examples of the acrylic ester monomer and/or methacrylic ester monomer include mono-functional acrylic ester monomers such as methyl acrylate, ethyl acrylate, propyl acrylate, butyl acrylate, 2-ethylhexyl acrylate, amyl acrylate, hexadecyl acrylate, octadecyl acrylate, butoxyethyl acrylate, phenoxyethyl acrylate, 2-hydroxyethyl acrylate and glycidyl acrylate; mono-functional methacrylic ester monomers such as methyl methacrylate, ethyl methacrylate, propyl methacrylate, butyl methacrylate, 2-ethylhexyl methacrylate, amyl methacrylate, hexadecyl methacrylate, octadecyl methacrylate, butoxyethyl methacrylate, phenoxyethyl methacrylate, 2-hydroxyethyl methacrylate and glycidyl methacrylate. Among these, methyl acrylate, methyl methacrylate, butyl acrylate, 2-ethylhexyl methacrylate and 2-ethylhexyl methacrylate are preferable. These may be used alone or in combination thereof.

Specific examples of the monomer copolymerizable with the acrylic ester monomer and/or methacrylic ester monomer include acrylamides; acid monomers such as acrylic acid, methacrylic acid, itaconic acid and maleic acid; aromatic vinyl compounds such as styrene and a styrene derivative; conjugated dienes such as 1,3-butadiene, 1,3-pentadiene, isoprene, 1,3-hexadiene and chloroprene; multi-functional monomers such as divinylbenzene and diacrylate; or the like. These may be used alone or in combination thereof.

Among these, in the case where the thermoplastic polymer (7) is a non-crosslinked type, it is preferable to use at least one kind of monomer selected from the group consisting of the above-described acrylamides, acid monomers and aromatic vinyl compounds. Further, in the case where the thermoplastic polymer (7) is a crosslinked or composite type, it is possible to essentially use any one of the above-described conjugated dienes or multi-functional monomers, and if necessary, at least one kind of monomer selected from the group consisting of the above-described acrylamides, acid monomers and aromatic vinyl compounds.

The thermoplastic polymer (7) may be any one of a non-crosslinked type or a crosslinked type, or a composite type having a core/shell structure consisting of a crosslinked core layer and a non-crosslinked shell layer, among which the composite type substantially spheroidal particles having a core/shell structure is preferable.

The core layer constituting the core/shell structure comprises an elastomer obtained by the copolymerization of the above-described acrylic ester monomer and/or methacrylic ester monomer, and a monomer copolymerizable therewith.

Specifically, the core layer preferably comprises an elastomer obtained by the copolymerization of usually 30 to 99.9% by weight of the acrylic ester monomer and/or methacrylic ester monomer, usually 0.1 to 70% by weight of a monomer copolymerizable therewith.

For the monomer copolymerizable with the acrylic ester monomer and/or methacrylic ester monomer, which is used in the core layer, either of the above-described conjugated dienes or the above-described polyfunctional monomers can be used as essential components, and if necessary, at least one kind of monomer selected from the group consisting of the above-described acrylamides, the above-described acid monomers and the above-described aromatic vinyl compounds can be used.

Further, in this case, the shell layer is obtained by the copolymerization of the above-described acrylic ester monomer and/or methacrylic ester monomer, and a monomer copolymerizable therewith, wherein for the monomer copolymerizable with the acrylic ester monomer and/or methacrylic ester monomer, at least one kind of monomer selected from the group consisting of the above-described acrylamides, the above-described acid monomers and the above-described aromatic vinyl compounds is preferably used.

As such, for the thermoplastic polymer (7), by using substantially spheroidal particles having a core/shell structure in which a shell layer of a non-crosslinked type is provided around the core layer of a crosslinked type on which a fine-crosslinked structure is imparted, the thermoplastic polymer (7) can fully serve as a stress-relaxing agent in the liquid crystal sealant composition.

Further, according to the invention, the particle surface of the thermoplastic polymer (7) thus formed is preferably fine-crosslinked. The method for fine-crosslinking the particle surface of the thermoplastic polymer (7), may be preferably exemplified by a method in which the epoxy group, the carboxyl group, the amino group or the like on the particle surface of the thermoplastic polymer (7) is metal-crosslinked, and ionomer-crosslinked.

By providing the fine-crosslinked structure with the particle surface of the thermoplastic polymer (7), the thermoplastic polymer does not tend to dissolve easily in an epoxy resin, a solvent, etc., at room temperature, whereby storage stability can be improved.

When the thermoplastic polymer (7) is used, the ingredient (7) is contained preferably in an amount of 2 to 40 parts by weight, and more preferably 5 to 25 parts by weight, based on 100 parts by weight of the liquid crystal sealant composition according to the invention. When the content of the thermoplastic polymer (7) is within this range, seal appearance is good, leakage of the ingredients of the liquid crystal sealant composition to liquid crystal and diffusion therein are prevented, and increase in the resin viscosity is also prevented, thereby allowing workability maintenance.

(8) Filler

The liquid crystal sealant composition of the invention may also be blended with a filler (8). This filler (8) may be any one as long as it is usually used as a filler in the electronic material field. Specific examples of the filler (8) include inorganic fillers such as calcium carbonate, magnesium carbonate, barium sulfate, magnesium sulfate, aluminum silicate, zirconium silicate, iron oxide, titanium oxide, aluminum oxide (alumina), zinc oxide, silicon dioxide, potassium titanate, kaolin, talc, asbestos powder, quartz powder, mica and glass fiber. For the filler, known organic fillers such as polymethyl methacrylate, polystyrene and copolymers of the monomers constituting thereof with other monomers copolymerizable therewith, (excluding thermoplastic polymer (7)) or the like can also be used. The filler (8) can be used after graft-modification with an epoxy resin, a silane coupling agent, or the like.

The maximum particle diameter of the filler used in the present invention is 10 μm or less, preferably 6 μm or less, and more preferably 4 μm or less, as measured by a laser diffraction method. When the maximum particle diameter is the above-described value or less, dimensional stability of the cell gap is further improved in the production of liquid crystal cells, which is thus preferable.

When the above-described filler is used, the above-described filler is desirably contained preferably in the amount of 1 to 40 parts by weight, and more preferably 10 to 30 parts by weight, based on 100 parts by weight of the liquid crystal sealant composition. When the content of the filler is within this range, application stability onto the glass substrate is good, light-curability also becomes good, and thus dimensional stability of the cell gap thickness is also improved.

(9) Other Additive

According to the invention, additives such as a heat radical generator, a coupling agent such as a silane coupling agent, anion trapping agent, an ion exchanger, a leveling agent, a pigment, a dye, a plasticizer and a defoaming agent can be used. Further, a spacer, etc., may be incorporated to assure the desired cell gap.

Processes for Producing One Component Resin Composition Curable with a Combination of Light and Heat, and Liquid Crystal Sealant Composition

The processes for producing the one component resin composition curable with a combination of light and heat, and the liquid crystal sealant composition according to the invention are not particularly limited, respectively, and can be obtained by mixing each of the above-described ingredients by means of an ordinary method. Mixing may be conducted by means of a known kneading machine such as a double arm stirrer, a roll mixer, a twin screw extruder and a ball mill, and the mixture may finally be subjected to vacuum degassing treatment, charged into a glass bottle or a plastic vessel that is tightly sealed, stored and transported.

Physical Properties of One Component Resin Composition Curable with a Combination of Light and Heat, and Liquid Crystal Sealant Composition

The viscosity of each of the one component resin composition curable with a combination of light and heat, and the liquid crystal sealant composition before curing is not particularly limited, and the viscosity at 25° C. as determined by an E type viscometer is preferably in the range of 30 to 1000 Pa·s, and more preferably 100 to 500 Pa·s.

Further, the thixotropic index represented by, for example, a ratio of a viscosity value at 0.5 rpm obtained, for example, at a shear rate of 1 cycle/minute to a viscosity value at 5 rpm obtained, for example, at a shear rate of 10 cycles/minute (viscosity value at 0.5 rpm/viscosity value at 5 rpm), by using the same rotor number of an E type viscometer, is not particularly limited, but it is preferably in the range of 1 to 5.

### <Liquid Crystal Display Panel and Process for Producing the Same>

The liquid crystal display panel of the invention can be prepared by using the liquid crystal sealant composition thus obtained by means of a one-drop-fill method. Specifically, one example of the production process will be described below.

The spacer having a predetermined gap thickness is incorporated into the liquid crystal sealant composition of the invention. Further, using a pair of glass substrates for a liquid crystal cell, the liquid crystal sealant composition is applied on one of the glass substrates in the frame pattern with a dispenser. The liquid crystal material corresponding to the internal capacity of the panel after being joined is precisely dropped within the defined range. The other glass is set to be opposite therewith, and 1000 to 18000 mJ of a UV ray is radiated under pressure to join the glass substrates. Thereafter, it is heated without additionally applied pressure at a temperature of 110° C. to 140° C. for 1 to 3 hours and sufficiently cured to form a liquid crystal display panel.

Examples of the substrate to be used for a liquid crystal cell include a glass substrate, a plastic substrate, or the like. It is a matter of course in the above-described substrates that a so-called liquid crystal cell-constituting a glass substrate or a plastic substrate is used, in which a transparent electrode, typically such as indium oxide, an alignment film, typically such as polyimide and in addition thereto, an inorganic ion-shielding film, and the like are provided on the needed parts.

The method for applying the liquid crystal sealant composition on the substrate for a liquid crystal cell is not particularly limited, and for example, a screen printing application method, a dispenser application method, or the like may be used.

The liquid crystal material is not particularly limited, and for example, nematic liquid crystal is preferred.

Examples of the liquid crystal display element in which the liquid crystal display panel of the invention can be applied, preferably include a TN type (Twisted Nematic) liquid crystal element and an STN type (Super Twisted Nematic) liquid crystal element which are proposed by M. Schadt and W. Helfrich, a ferroelectric type liquid crystal element proposed by N. A. Clark and S. T. Lagerwall and a liquid crystal display element provided on each pixel with a thin film transistor (TFT).

Hereinbelow, the present invention shall be explained in detail with reference to representative examples, but the invention shall not be limited thereto. Percentages and parts as described herein mean % by weight and parts by weight, respectively.

The raw materials to be used and the test methods to be carried out in the following examples are as follows.

### <Raw Materials to be Used>

(1) Epoxy Resin

As the epoxy resin of the above-described ingredient (1), an o-cresol Novolac type solid epoxy resin (EOCN-1020-75 manufactured by Nippon Kayaku Co., Ltd.; softening point, as measured by a ring and ball method, of 75° C., and number average molecular weight, as measured by GPC, of 1100) was used.

(2) Acrylic Ester Monomer and/or Methacrylic Ester Monomer or Oligomer Thereof.

As the acrylic ester monomer and/or methacrylic ester monomer, or an oligomer thereof as the above-described ingredient (2), pentaerythritol triacrylate (Viscoat #300 manufactured by Osaka Organic Chemical Industry Co., Ltd.; sp value of 11.1, and number average molecular weight of 298) was diluted three times and washed with toluene and ultrapure water, and subjected to high-purity treatment for use.

(3) Latent Epoxy Curing Agent

As the latent epoxy curing agent, 1,3-bis(hydrazinocarboethyl)-5-isopropyl hydantoin (Amicure VDH-J manufactured by Ajinomoto-Fine-Techno Co., Inc.; melting point of 120° C.), and 2,4-diamino-6-[2′-methylimidazolyl-(1′)]-ethyl-s-triazine isocyanuric acid adduct (Curezole 2MA-OK manufactured by Shikoku Chemicals Corporation; melting point of 220° C.) were used.

(4) Photo Radical Initiator

As the photo radical initiator, 1-hydroxy-cyclohexyl-phenyl-ketone (Irgacure 184 manufactured by Ciba Specialty Chemicals K. K.) was used.

(5) Compound Having Two or More Thiol Groups Per Molecule

As the compound having two or more thiol groups per molecule, trimethylolpropane tris(3-mercaptopropionate) (3TP-6 manufactured by Maruzen Petrochemical Co., Ltd.; number average molecular weight of 399) was used.

(6) Partially Esterified Epoxy Resin Obtained by the Reaction of an Epoxy Resin with a Compound Having Both at Least One Acryloyl Group or Methacryloyl Group, and at Least One Carboxyl Group Per Molecule

As the above-described ingredient (6), the partially esterified epoxy resin synthesized in the following Synthesis Example 1 was used.

### Synthesis Example 1

### Synthesis of partially Esterified Epoxy Resin

A 500-ml, four-neck flask equipped with a stirrer, a gas inlet tube, a thermometer and a condenser was charged with 160 g of a bisphenol F type epoxy resin (Epotohto YDF-8170C manufactured by TOHTO KASEI Co., Ltd.), 43 g of methacrylic acid and 0.2 g of triethanolamine, and the mixture were mixed and heated at 110° C. for 5 hours under a dry air flow with stirring, to obtain a methacryloyl group-containing, partially esterified epoxy resin. The obtained material was subjected to washing treatment with ultrapure water three times.

(7) Thermoplastic Polymer Having a Softening Point of 50 to 120° C., which is Obtained by the Copolymerization of an Acrylic Ester Monomer and/or Methacrylic Ester Monomer, and a Monomer Copolymerizable Therewith

As the thermoplastic polymer of the ingredient (7), the thermoplastic polymer synthesized according to the following Synthesis Example 2 was used.

### Synthesis Example 2

### Synthesis of Thermoplastic Polymer of the Ingredient (7)

A 1000-ml, four-neck flask equipped with a stirrer, a nitrogen inlet tube, a thermometer and a ref lux condenser was charged with 400 g of ion exchange water, and 1.0 g of sodium alkyldiphenyletherdisulfonate, and the temperature was raised to 65° C. 0.4 g of potassium persulfate was added thereto, followed by 4-hour continuous dropwise addition of a mixed solution which had been prepared by emulsifying a mixture consisting of 1.2 g of t-dodecylmercaptan, 156 g of n-butyl acrylate, 4.0 g of divinylbenzene, 3.0 g of sodium alkyldiphenyletherdisulfonate and 200 g of ion exchange water by means of a homogenizer. After the dropwise addition, reaction was further carried out for 2 hours, and 232 g of methyl methacrylate was added all at once. After reaction was further carried out for 1 hour, 8 g of acrylic acid was continuously added over 1 hour. Then, the reaction was carried out for 2 hours at a constant temperature of 65° C., followed by cooling. The resulting solution was neutralized to pH=7 with potassium hydroxide, to obtain an emulsion solution containing 40.6% by weight of solids. 1000 g of this emulsion solution was spray dried by a spray drier to obtain about 400 g of high-softening point particles with moisture contents of 0.1% or less. The high-softening point particles had a softening temperature of 80° C. The particle diameter of the high-softening point particles was measured with an N-4 Coulter counter, and the average particle diameter was 180 nm.

(8) Filler

As the filler, ultra-high-purity silica (SO-E1 manufactured by Admatechs Co., Ltd.; average particle diameter of 0.3 μm) was used.

(9) Additive

As the additive, γ-glycidoxypropyltrimethoxysilane (KBM403 manufactured by Shin-Etsu Chemical Co., Ltd.) as a silane coupling agent was selected and used.

### <Test Methods>

(i) Test on Viscosity Stability

The initial viscosity of the resin composition at 25° C. was measured by an E type viscometer, and a polyethylene vessel was charged with 100 parts of the resin composition and tightly sealed. Then, after storage at −10° C. for 30 days, the viscosity value was measured by the E type viscometer. The result was shown by a change rate, with reference to the viscosity value measured after storage at −10° C. for 30 days, wherein the viscosity value at 25° C. before sealing was set at 100. The change rate of less than 10% represents good storage stability, which was indicated by the symbol A in Examples; the change rate of 10% to 50% represents slightly poor storage stability, which was indicated by the symbol B in Examples; and the change rate of more than 50% represents poor storage stability, which was indicated by the symbol C in Examples.

(ii) Measurement of Gel Fraction of Cured Product After Heat-Curing

The resin composition was applied at a thickness of about 120 μm, and heat-treated in an oven at 120° C. for 60 minutes under nitrogen atmosphere, 1.0 g of the obtained cured product having a thickness of 100 μm after heat-curing was extracted with 100 g of methanol as an extraction solvent by means of a Soxhlet extraction under reflux for 3 hours, and the cured product after extraction was dried at 105° C. for 3 hours. Then, the gel fraction of the cured product after heat-curing was calculated by using the weight change of the cured product before and after extraction in accordance to the following equation.

Gel fraction of cured product after heat-curing (%) {(Weight of cured product after extraction with methanol and drying)/(Weight of cured product before after extraction with methanol)}×100

The gel fraction of the cured product after heat-curing of more than 75% represents good heat-curability (curability in the light-shielded area), which was indicated by the symbol A in Examples; the gel fraction of the cured product after heat-curing of 60 to 75% represents slightly poor heat-curability (curability in the light-shielded area), which was indicated by the symbol B in Examples; and the gel fraction of the cured product after heat-curing of less than 60% represents poor heat-curability (curability in the light-shielded area), which was indicated by the symbol C in Examples.

(iii) Measurement of Adhesive Strength of Resin Composition After Curing with Combination of Light and Heat

1 part by weight of 5-μm glass fibers were added to 100 parts by weight of the resin composition, which was screen printed on an alkali-free glass of 25 mm×45 mm×thickness 5 mm in the circular shape having a diameter of 1 mm. A similar counter glass was crosswise superposed to join them, fixed under loading and light-curing was performed using a UV radiator manufactured by Toshiba Corporation with an exposure energy of 2000 mJ at a ultraviolet radiation of 100 mW/cm². Then, the adhesion specimen after light-curing as described above was subject to heat-treatment in an oven at 120° C. for 60 minutes under nitrogen atmosphere, and the resultant specimen was tested on plane tensile strength at a pulling rate of 2 mm/min using a tensile tester (Model 210; Intesco Co., Ltd.), which was referred to as an adhesive strength (MPa).

(iv) Test on Adhesion Reliability After Storage Under High-Temperature and High-Humidity

The adhesion specimen was produced in the same manner as in the above-described (iii) Measurement of resin composition after curing with a combination of light and heat, and the resultant adhesion specimen was stored in a high-temperature and high-humidity tester at a temperature of 60° C. and a humidity of 95%, and the specimen obtained after 250-hour storage was tested on plane tensile strength at a pulling rate of 2 mm/min using a tensile tester (Model 210; Intesco Co., Ltd.).

The maintenance of the adhesive strength relative to the adhesive strength before the high-temperature and high-humidity storage of more than 50% represents good adhesion reliability after the high-temperature and high-humidity storage, which was indicated by the symbol A in Examples; the maintenance of 30 to 50% represents slightly poor adhesion reliability after the high-temperature and high-humidity storage, which was indicated by the symbol B in Examples; and the maintenance of less than 30% represents poor adhesion reliability after the high-temperature and high-humidity storage which was indicated by the symbol C in Examples.

(v) Test on Display Characteristics of Liquid Crystal Display Panel

1 part by weight of 5-μm glass fibers were added to 100 parts by weight of the resin composition, which was drawn on a glass substrate of 40 mm×45 mm (RT-DM88PIN manufactured by EHC Corporation), which was provided with a transparent electrode and an alignment film, using a dispenser (shot master manufactured by Musashi Engineering, Inc.) having a frame pattern of 35 mm×40 mm with a line width of 0.5 mm and a thickness of 20 μm. Then, the liquid crystal materials (MLC-11900-000 manufactured by Merck Ltd.) corresponding to the internal capacity of the panel after being joined were precisely dropped within the defined range using a dispenser. The glass substrates to be paired were joined under reduced pressure, fixed under loading, and light-curing was performed using a UV radiator manufactured by Toshiba Corporation with an exposure energy of 2000 mJ at a ultraviolet radiation of 100 mW/cm². Then, the adhesion specimen after light-curing was heat-treated in an oven at 120° C. for 60 minutes under nitrogen atmosphere, and polarized films were attached on both sides thereof, so as to obtain a liquid crystal display panel.

Display characteristics of the panel regarding whether the liquid crystal display functions around the liquid crystal sealant (the resin composition after curing) are normally performed from the early driving stage when driving the obtained liquid crystal display panel at 5 V of an applied voltage using a direct current power source device, were evaluated.

In this evaluation method, the case where the liquid crystal display functions were performed well until sealing represents good display characteristics, which was indicated by the symbol A in Examples; the case where the liquid crystal display functions were not performed normally in the area within 0.5 mm therefrom upon sealing represents slightly poor display characteristics, which was indicated by the symbol B in Examples; and the case where the liquid crystal display functions were performed abnormally in the area beyond 0.5 mm therefrom upon sealing represents poor display characteristics, which was indicated by the symbol C in Examples.

(vi) Test on Display Characteristics in Light-Shielded Area of Liquid Crystal Display Panel

1 part by weight of 5-μm glass fibers were added to 100 parts by weight of the resin composition, which was drawn on a glass substrate of 40 mm×45 mm (RT-DM88PIN manufactured by EHC Corporation), which was provided with a transparent electrode and an alignment film, using a dispenser (shot master manufactured by Musashi Engineering, Inc.) having the frame pattern of 35 mm×40 mm with a line width of 0.5 mm. Then, the liquid crystal materials (MLC-11900-000 manufactured by Merck Ltd.) corresponding to the internal capacity of the panel after being joined were precisely dropped within the defined range using a dispenser. The glass substrates to be paired were joined under reduced pressure, fixed under loading, and sealing part of upper substrate was covered with aluminum tape to prevent direct exposure of UV light. Then, light-curing was performed using a UV radiator manufactured by Toshiba Corporation with an exposure energy of 500 mJ at a ultraviolet radiation of 100 mW/cm². Then, it was subject to heat-treatment at 120° C. for 60 minutes and provided with a shielded are a to produce a liquid display panel. Aluminum tape was peeled and then polarized films were attached on both sides thereof. Then, in the same manner as described above, display functions upon sealing the liquid crystal display panel were observed.

In this evaluation method, the case where the liquid crystal display functions were performed well until sealing represents good display characteristics, which was indicated by the symbol A in Examples; the case where the liquid crystal display functions were not performed normally in the area within 0.5 mm therefrom upon sealing represents slightly poor display characteristics, which was indicated by the symbol B in Examples; and the case where the liquid crystal display functions were not performed abnormally in the area beyond 0.5 mm therefrom upon sealing represents poor display characteristics, which was indicated by the symbol C in Examples.

### Example 1

25 parts of the ingredient (1) and 30 parts of the ingredient (2) were heated and dissolved to form a uniform solution, to which 6 parts of 1,3-bis(hydrazinocarboethyl)-5-isopropyl hydantoin (Amicure VDH-J) and 1 part of 2,4-diamino-6-[2′-methylimidazolyl-(1′)]-ethyl-s-triazine isocyanuric acid adduct (Curezole 2MA-OK) as the ingredient (3), 1 part of the ingredient (4), 15 parts of the ingredient (7), 1 part of the ingredient (5), 20 parts of the ingredient (8), and 1 part of the ingredient (9) were added, and preliminarily mixed in the mixer, and then kneaded with three rolls until the solid material had a size of 5 μm or less. This mixture was subjected to vacuum degassing treatment to obtain a resin composition (P1).

This resin composition (P1) had an initial viscosity at 25° C., as measured by an E type viscometer, of 250 Pa·s.

In regards to this resin composition (P1), the above tests (i) to (vi) were carried out. The results are shown in Table 2.

### Examples 2, 3 and 4

In the same manner as in Example 1, except that the ingredients were blended according to the formulation as in Table 1, respectively, to obtain resin compositions (P2), (P3) and (P4), and evaluations were carried out in the same manner as in Example 1. The results are summarized in Table 2.

### Comparative Example 1

In the same manner as in Example 1, except that the ingredients (5) and (6) were not used, and the ingredients were blended according to the formulation as in Table 1, to obtain a resin composition (C1), and evaluation was carried out in the same manner as in Example 1. The results are shown in Table 2.

### Comparative Example 2

In the same manner as in Example 1, except that 10 parts by weight of the ingredient (5) was used, and the ingredients were blended according to the formulation as in Table 1, to obtain a resin composition (C2), and evaluation was carried out in the same manner as in Example 1. The results are shown in Table 2.

### Comparative Example 3

In the same manner as in Example 1, except that the ingredients (1), (3) and (6) were not used, the molar ratio of the thiol group of the ingredient (5) to the acryloyl group of the ingredient (2) of 1:1 were used, and the ingredients were blended according to the formulation as in Table 1, to obtain a resin composition (C3), and evaluation was carried out in the same manner as in Example 1. The results are shown in Table 2.

TABLE 1

| | | | | | | Comparative | | |
|---|---|---|---|---|---|---|---|---|
| | | Examples | | | | Examples | | |
| | | 1 | 2 | 3 | 4 | 1 | 2 | 3 |
| Resin Composition | | P1 | P2 | P3 | P4 | C1 | C2 | C3 |
| (1) Epoxy resin | Solid epoxy | 25 | 5 | 5 | 20 | 25 | 20 | — |
| | resin | | | | | | | |
| | EOCN-1020-75 | | | | | | | |
| (2) Acrylic ester and/or | Viscoat #300 | 30 | 35 | 35 | 25 | 30 | 25 | 24 |
| methacrylic ester or | | | | | | | | |
| oligomer thereof | | | | | | | | |
| (3) Latent epoxy curing | Amicure VDH-J | 6 | 6 | 6 | 6 | 6 | 6 | — |
| agent | Curezole 2MA-OK | 1 | 1 | 1 | 1 | 1 | 1 | — |
| (4) Photo radical | Irgacure 184 | 1 | 1 | 1 | 1 | 1 | 1 | 1 |
| initiator | | | | | | | | |
| (5) Compound having two or | 3TP-6 | 1 | 2 | 2 | 1 | — | 10 | 32 |
| more thiol groups per | | | | | | | | |
| molecule | | | | | | | | |
| (6) Partially esterified | Synthesis Example 1 | — | 20 | 20 | 10 | — | — | — |
| epoxy resin | | | | | | | | |
| (7) Thermoplastic | Synthesis Example 2 | 15 | 10 | — | 15 | 15 | 16 | 22 |
| polymer | | | | | | | | |
| (8) Filler | SO-E1 | 20 | 20 | 30 | 20 | 21 | 20 | 20 |
| (9) Additive | KBM403 | 1 | — | — | 1 | 1 | 1 | 1 |

* In Table 1, the units of values are represented by parts by weight.

(1) Epoxy Resin;

Solid Epoxy resin; EOCN-1020-75 (manufactured by Nippon Kayaku Co., Ltd., o-cresol Novolac type solid epoxy resin, softening point of 75° C., and number average molecular weight of 1100)

(2) Acrylic Ester and/or Methacrylic Ester or Oligomer Thereof;

Viscoat #300 (Osaka Organic Chemical Industry Co., Ltd.); pentaerythritol triacrylate (molecular weight of 298, SP value of 11.1)

(3) Latent Epoxy Curing Agent;

Amicure VDH-J (manufactured by Ajinomoto-Fine-Techno Co., Inc.); 1,3-bis(hydrazinocarboethyl)-5-isopropyl hydantoin (melting point of 120° C.)

Curezole 2E4MZ-A (manufactured by Shikoku Chemicals Corporation); 2,4-diamino-6-[2′-methylimidazolyl-(1′)]-ethyl-s-triazine isocyanuric acid adduct (melting point of 220° C.)

(4) Photo Radical Initiator;

Irgacure 184 (manufactured by Ciba Specialty Chemicals K. K.); 1-hydroxy-cyclohexyl-phenyl-ketone

(5) Compound Having Two or More Thiol Groups Per Molecule;

3TP-6 (manufactured by Maruzen Petrochemical Co., Ltd.); trimethylolpropane tris(3-mercaptopropionate) (molecular weight of 399)

(6) Partially Esterified Resin

Synthesis Example 1; partially esterified epoxy resin with methacrylic acid of Bisphenol F type epoxy resin

(7) Thermoplastic Polymer

Synthesis Example 2 (Softening point of 80° C., particle diameter of 0.18 μm)

(8) Filler

SO-E1 (manufactured by Admatechs Co., Ltd.); ultra-high-purity silica

(9) Additive

KBM403 (manufactured by Shin-Etsu Chemical Co., Ltd.); γ-glycidoxypropyltrimethoxysilane

TABLE 2

| | Example No. | | | | | | |
|---|---|---|---|---|---|---|---|
| | | | | | Comparative | Comparative | Comparative |
| Test items | Example 1 | Example 2 | Example 3 | Example 4 | Example 1 | Example 2 | Example 3 |
| Resin composition | P1 | P2 | P3 | P4 | C1 | C2 | C3 |
| (i) Viscosity | A | A | A | A | A | C | A |
| stability | | | | | | | |
| (ii) Gel fraction | 82 | 77 | 76 | 78 | 78 | — | 50 |
| (%) of cured | | | | | | | |
| product after | | | | | | | |
| heat-curing | | | | | | | |
| (iii) Adhesive | 25.2 | 23.3 | 21.5 | 28.0 | 10.0 | — | 4.2 |
| strength (MPa) | | | | | | | |
| after curing with a | | | | | | | |
| combination of | | | | | | | |
| light and heat | | | | | | | |
| (iv) | A | A | A | A | C | — | C |
| High-temperature | | | | | | | |
| and high-humidity | | | | | | | |
| adhesion | | | | | | | |
| reliability | | | | | | | |
| (v) Test on display | A | A | A | A | B | — | B |
| characteristics of | | | | | | | |
| liquid crystal | | | | | | | |
| display panel | | | | | | | |
| (vi) Test on | A | A | A | A | B | — | C |
| display | | | | | | | |
| characteristics of | | | | | | | |
| liquid crystal | | | | | | | |
| display panel in | | | | | | | |
| light-shielded | | | | | | | |
| area | | | | | | | |

As clearly shown from the results of Table 2, since the resin compositions P1 to P4 of Examples had good viscosity stability, and high gel fraction of the cured product after heat-curing, it was confirmed that they had excellent adhesion characteristics after curing with a combination of light and heat, adhesion reliability after storing under high-temperature and high-humidity, display characteristics of the liquid crystal display panel, and display characteristics of the light-shielded area. Therefore, it was found that these resin compositions can be preferably used as the liquid crystal sealant composition.

On the other hand, the resin composition C1 of Comparative Example 1 had poor adhesiveness and high-temperature and high-humidity adhesion reliability, as well as poor display characteristics of the liquid crystal display panel. Therefore, it was found that this resin composition is undesirable as the liquid crystal sealant composition. Further, the resin composition C2 of Comparative Example 2 had poor storage stability, and thus it could not be available on the above-described test items (ii) to (vi).

The resin composition C3 of Comparative Example 3 had poor adhesiveness and low gel fraction after heat-curing, and thus poor display characteristics, and display characteristics in the light-shielded area. Therefore, it could be found that this resin composition is undesirable as the liquid crystal sealant composition.

1. The one component resin composition curable with a combination of light and heat according to claim 1, which comprises a partially esterified epoxy resin (6) obtained by the reaction of an epoxy resin with a compound having both at least one acryloyl group or methacryloyl group, and at least one carboxyl group per molecule.

2. A liquid crystal sealant composition, which comprises the one component resin composition curable with a combination of light and heat according to claim 1.
